(19) United States
(12) Patent Application Publication
(10) Pub. No.: US 2004/0268349 A1
(43) Pub. Date: Dec. 30, 2004

(54) Systems, methods and computer program products for assigning at least one task to at least one shift

(75) Inventors: Vishwamitra S. Ramakrishnan, Cambridge, MA (US); Stacy M. Dugan, Grapevine, TX (US); Puneet Kohli, Arlington, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sabre Inc., Southlake, TX

(21) Appl. No.: 10/610,135

(22) Filed: Jun. 30, 2003

(51) Int. Cl. G06F 9/46

(52) U.S. Cl. 718/100

(57) ABSTRACT

Systems, methods and computer program products are provided for assigning at least one task to at least one shift. Typically, the method begins by receiving task assignment data, where the task assignment data includes at least one task, at least one shift and at least one priority associated with the at least one task. After receiving the task assignment data, at least one set of task/shift assignments is generated based upon the task assignment data, where each set of task/shift assignments has an associated solution value. After generating the task/shift assignments, an optimum set of task/shift assignments is selected based upon the generated sets of task/shift assignments and a quantitative measure of quality associated with the optimum set of shift schedules, where the quantitative measure of quality is based upon a threshold value and a solution value associated with the optimum set of task/shift assignments.

### FIELD OF THE INVENTION

The present invention generally relates to task assignment systems and, more particularly, relates to systems, methods and computer program products for assigning at least one task to at least one shift with a quantitative measure of quality.

### BACKGROUND OF THE INVENTION

In many industries today, such as the airline industry, organizations must continuously assign a given set of tasks to shifts according to which workers of the respective organizations will perform the given tasks over a planning period. As known to those skilled in the art, the task assignment problem generally involves optimally assigning tasks to shifts such that the task assignments are fully contained within the shifts to which they are assigned and do not overlap each other or any shift breaks, with all applicable constraints to such assignments taken into consideration. As will be appreciated, task assignments for many large organizations can be a difficult, complex planning and control process.

In task assignment scenarios, several requirements must be considered depending upon the particular conditions and policies of the respective organization. For example, an organization may be required to consider shift check-in and check-out times, which may be represented as the amount of time at the beginning and/or end of a shift in which no task assignment may overlap. Also, for example, an organization may be required to consider partially covered tasks, which may be represented by the percentage of a task that may go uncovered by a shift (i.e., “hang” off the front/end of a shift, or overlap into a shift break). In addition, an organization may be required to consider the amount of time required between the assignment of two specific task assignments (i.e., the end time of one task and the start time of the next task). Further, an organization may be required to consider break travel times (i.e., a duration of time added to the beginning and the end of a shift break during which no task assignment may be made).

While an organization may have any of a number of different objectives in assigning tasks to shifts, in one typical implementation, task assignment systems seek to maximize the weight, or priority, of the tasks assigned to the shifts. In such instances, each task has an associated quantitative weight, or priority value. Then, as the number of available shifts may be outnumbered by the number of tasks, the objective of the task assignment system is to assign the highest priority tasks to the available shifts, while accounting for all of the constraints or requirements placed on an organization in assigning the tasks. In another typical implementation, task assignment systems seek to minimize a cost associated with the tasks assigned to the shifts, which may be representative of the total number of shifts required to cover the tasks, the total duration of the shifts needed to cover the tasks, or the total idle time across all shifts.

Conventionally, assigning tasks to shifts has been accomplished according to a number of different techniques. For example, many systems perform task assignments according to a heuristic technique whereby tasks are assigned to shifts by sophisticated trial-and-error methods. Whereas conventional heuristic techniques are adequate to generate task assignments, such techniques have drawbacks. In this regard, heuristic assignment techniques do not typically provide control over the quality of the match between the tasks and shifts. More particularly, heuristic assignment techniques do not provide any measure of the quality of the match between tasks and shifts such that the match can be improved, if so desired. Additionally, in some instances, it has been found that the task assignments generated by the heuristic technique can be improved by manually altering the generated task assignments. Also, heuristic techniques can, at times, exhibit a counter-intuitive behavior. For example, the task assignments generated according to a heuristic technique may find better solutions with the addition of one or more new constraints such as blackouts and travel times.

### SUMMARY OF THE INVENTION

In light of the foregoing background, embodiments of the present invention provide improved systems, methods and computer program products for assigning at least one task to at least one shift. Embodiments of the present invention are capable of generating at least one, and more typically, an optimum set of task/shift assignments based upon a quantitative measure of quality. By selecting the set of task/shift assignments based upon the quantitative measure of quality, embodiments of the present invention facilitate selecting an optimum set of task/shift assignments that has a desired level of quality. Further, embodiments of the present invention are capable of repeatedly generating different sets of task/shift assignments until a set of task/shift assignments is found that has the desired level of quality. As will be appreciated, the higher number of sets of task/shift assignments that are generated, the higher the probability of selecting a set of task/shift assignments having a high level of quality. As such, embodiments of the present invention facilitate control over the quality of the optimum set of task/shift assignments and the processing time required to select the optimum set of task/shift assignments. In this regard, by decreasing the desired level of quality, the time required to select the optimum set of task/shift assignments can be similarly decreased. Alternatively, by increasing the time required to select the optimum set of task/shift assignments, the desired level of quality can be increased.

According to one aspect of the present invention, a method is provided for assigning at least one task to at least one shift. Typically, the method begins by receiving task assignment data, where the task assignment data includes at least one task, at least one shift and at least one priority associated with the at least one task. After receiving the task assignment data, at least one set of task/shift assignments is generated based upon the task assignment data. Each set of task/shift assignments includes at least one task assigned to at least one shift, and each set of task/shift assignments has an associated solution value based upon the priorities of the tasks included within the respective task/shift assignment.

After generating the task/shift assignments, an optimum set of task/shift assignments is selected based upon the generated sets of task/shift assignments and a quantitative measure of quality associated with the optimum set of task/shift assignments. The quantitative measure of quality is based upon a threshold value and a solution value associated with the optimum set of task/shift assignments. In this regard, before selecting the optimum set of task/shift assignments, the threshold value can be determined based upon the task assignment data. For example, the threshold value can be determined by determining a value representative of the maximum sum of the priorities associated with the tasks included within any set of task/shift assignments capable of being selected in accordance with the task assignment data.

The optimum set of task/shift assignments can be selected such that the optimum set has an associated solution value within a predefined acceptable variation from the threshold value. More particularly, the sets of task/shift assignments can be generated, and the optimum set of task/shift assignments selected, by first generating a set of task/shift assignments. Thereafter, a solution value associated with the set of task/shift assignments can be compared to the threshold value. In this manner, sets of task/shift assignments can be repeatedly generated and compared to the threshold value until an optimum set of task/shift assignments is selected that has an associated solution value within a predefined acceptable variation from the threshold value.

The sets of task/shift assignments can be generated in accordance with at least one business rule. More particularly, the sets of task/shift assignments can be generated to incorporate at least one fixed lunch break when the task assignment data includes at least one shift defining at least one lunch break. In this regard, the optimum set of task/shift assignments can be selected as the optimum set of task/shift assignments with at least one fixed lunch break. Additionally, or alternatively, the sets of task/shift assignments can be generated to maximize the sum of the priorities associated with the tasks within the respective sets of task/shift assignments while (a) preventing any pair of overlapping tasks from being assigned to the same shift, (b) preventing any task from overlapping any fixed lunch break defined for any shift, (c) preventing any pair of tasks that overlap due to a travel time associated with each of the pair of tasks from being assigned to the same shift, and/or (d) ensuring that any plurality of linked tasks are assigned to the same shift.

In embodiments where the generated sets of task/shift assignments include at least one fixed lunch, the method can further include determining whether the lunch breaks defined for the shifts are permitted to float within the respective shift. Then, a determination can be made as to whether an optimum set of task/shift assignments with at least one floating lunch break provides an improvement over the optimum set of task/shift assignments with at least one fixed lunch. In this regard, the determination can be made based upon the solution value of the optimum set of task/shift assignments with at least one fixed lunch. Before the determination is made, a threshold usefulness can be determined based upon a solution value associated with a set of task/shift assignments independent of fixed lunch breaks. Then, the determination can be made further based upon the threshold usefulness.

Thereafter, if the lunch breaks are permitted to float and the optimum set of task/shift assignments with at least one floating lunch break provides an improvement, sets of task/shift assignments can be generated to incorporate at least one floating lunch break. Then, an optimum set of task/shift assignments with at least one floating lunch break can be selected based upon the generated sets of task/shift assignments with at least one floating lunch break. As will be appreciated, the optimum set of task/shift assignments with at least one floating lunch break is selected if the at least one set of task/shift assignments with at least one floating lunch break is generated.

According to other aspects of the present invention, a system and computer program product are provided for assigning at least one task to at least one shift. Therefore, embodiments of the present invention provide improved systems, methods and computer program products for assigning at least one task to at least one shift. Embodiments of the present invention are capable of generating at least one, and more typically, an optimum set of task/shift assignments based upon a quantitative measure of quality to thereby facilitate selecting an optimum set of task/shift assignments that has a desired level of quality. In this regard, embodiments of the present invention are capable of repeatedly selecting different sets of task/shift assignments until a set of task/shift assignments is found that has the desired level of quality, thereby providing increased control over the quality of the optimum set of task/shift assignments and the processing time required to select the optimum set of task/shift assignments. As such, the systems, methods and computer program products of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIGS. 1A and 1B are flowcharts illustrating various steps in a method of assigning at least one task to at least one shift according to one embodiment of the present invention; and

FIG. 2 is a schematic block diagram of a system for assigning at least one task to at least one shift according to one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

According to one aspect of the present invention, a method is provided for assigning one or more tasks to one or more shifts. As used herein, a shift schedule comprises a schedule for a worker over a planning period. The shift schedule may contain one or more shifts for the worker, and may cover a planning period of a day or more with any off days included. For example, one shift schedule may comprise the following: Sunday 9 am-5 pm; Monday 9 am-5 pm; Tuesday off; Wednesday 8 am-4 pm; Thursday off; Friday 2 pm-8 pm; and Saturday 2 pm-8 pm. As will be appreciated, then, whereas the method of embodiments of the present invention can assign one or more tasks to one or more shifts, the method typically assigns a plurality of tasks to a plurality of shifts.

The method of embodiments of the present invention can advantageously assign one or more tasks to one or more shifts while incorporating one or more optional processes, each adding one or more business rules or constraints. The tasks can be assigned to shifts with any of a number of different goals. For example, the tasks can be assigned to the shifts to maximize the number of assigned tasks, or alternatively, minimizing the number of unassigned tasks. Further, for example, the tasks can include an associated priority value such that the tasks can be assigned to the shifts to maximize the sum of the task priorities in the set of task/shift assignments. According to the following description, the tasks are assigned to the shifts to maximize the sum of the task priorities in the task/shift assignments. In this regard, as used herein, the sum of the task priorities (weighted or otherwise) in a set of task/shift assignments may be referred to as the solution value of the respective set of task/shift assignments. It should be understood, however, that the following description is equally applicable to instances of maximizing the number of assigned tasks or minimizing the number of unassigned tasks, without departing from the spirit and scope of the present invention.

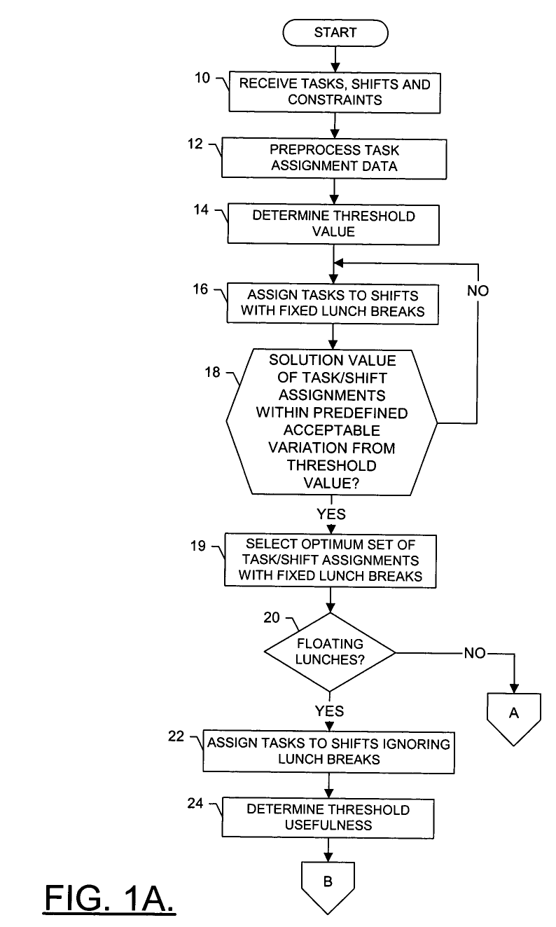

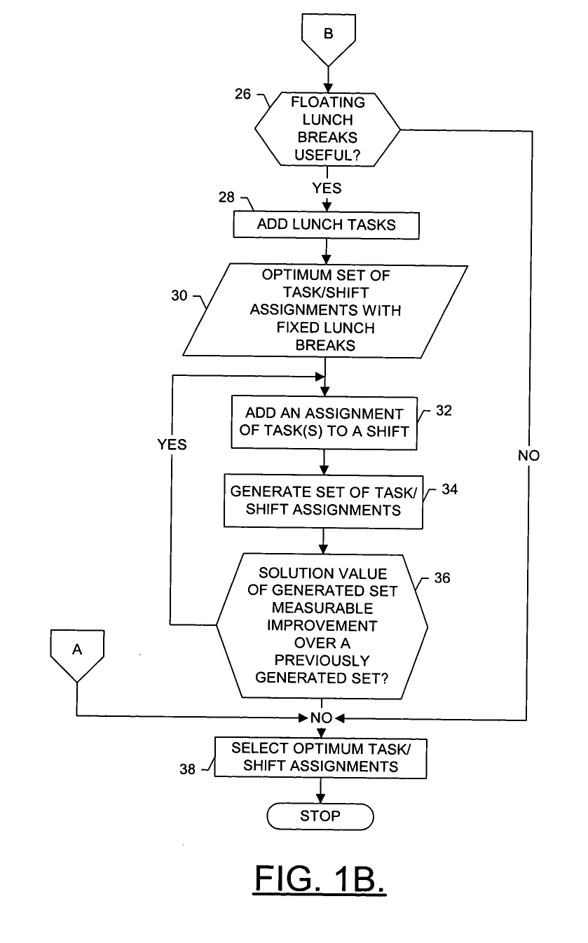

Referring now to FIG. 1, a method of assigning at least one task to at least one shift, according to one embodiment of the present invention, generally begins by receiving task assignment data, such as one or more shifts and one or more tasks, as shown in block 10. In this regard, each shift may be defined by a start day and time, a duration and, if desired, one or more breaks, such as for meals (e.g., lunch), appointments (e.g., doctor appointments) and the like, which are collectively referred to herein as a “lunch break.” Similarly, each task may be defined by a start day and time, and a duration. According to embodiments of the present invention, each pair of tasks may be defined by a travel time comprising the time required between the assignment of two specific task assignments (i.e., the end time of the first task and the start time of the second task). One or more pluralities of tasks can also be defined by a link between the respective tasks such that if one is assigned to a shift, the other linked tasks must also be assigned to the same shift. In addition, shifts and/or tasks may be defined by qualifications such that tasks may only be assigned to shifts with matching qualifications. Further, one or more shifts and/or tasks may each have a set of qualifications such that a particular task can be assigned to a particular shift only if the set of qualifications associated with the respective task is a subset of the set of qualifications associated with the respective shift.

Advantageously, each task may also be defined by a quantitative priority value that is associated with the respective task and represents a weight or a priority to the respective task relative to the other tasks received. By so defining the quantitative priority value, the method of embodiments of the present invention are capable of maximizing the sum of the task priorities in (i.e., the solution value) of a set of task/shift assignments, particularly when not all the received tasks are capable of being assigned to received shifts while being subjected to a number of business rules or constraints.

As used herein, an optimum (i.e., selected) set of task/shift assignments comprises one or more tasks assigned to one or more shifts while satisfying all of the business rules and constraints, and is also associated with a desired (e.g., high) solution value when compared against other sets of task/shift assignments. It should be understood, however, that the optimum set of task/shift assignments is not necessarily the best set of set of task/shift assignments that satisfy all of the business rules and constraints, and is not necessarily associated with the greatest solution value. In this regard, as explained more fully below, the optimum set of task/shift assignments can comprise a set of task/shift assignments that has a solution value at least a predefined acceptable variation from a threshold value. Alternatively, the optimum set of task/shift assignments can comprise a set of task/shift assignments that has a number of tasks at least a predefined acceptable variation from a threshold number of assigned tasks. While these examples of the optimum set of task/shift assignments may not have the greatest solution value, these examples of the optimum set may be derived in less time than other sets of task/shift assignments that have a higher solution value. Thus, in these examples, the final solution including the optimal set of task/shift assignments may be characterized by the processing time permitted to determine the final solution and the predefined acceptable variable from the threshold value.

Although the priority of a given task type, n, can be defined in any of a number of different manners, a typical example of a “priority” is one of a number of consecutive integer values (e.g., 1-10). In such an instance, a priority of 0 indicates a default priority, and priority values above 0 indicate a relative priority of respective tasks to the default priority. To differentiate between ties in task assignments, the priority values can be weighted. The priority values can be weighted in any of a number of different manners. In one embodiment, for example, to weight the priority values, objective function weights can be determined as follows: if the priority value equals 0, the priority weight=1; and if the priority value is greater than zero, the priority weightₙ=2×priority weightₙ₋₁+1. As an example, consider three task types with priority values of 0, 1, and 2 respectively. In this example, the first task type will be given a priority weight of 1, the second task type will be given a priority weight of 3 (i.e. 2(1)+1), and the third task type will be given a priority weight of 7 (i.e., 2(3)+1).

To illustrate how weighting the priority values may facilitate differentiating between ties in task assignments, consider that a priority value tie situation exists when choosing between two priority 1 tasks or one priority 2 task if incremental priority values (i.e. 1, 2) are used. But by weighting the priority values, the priority 2 task will be chosen over the two priority 1 tasks since the priority 2 task has a weight of 7, whereas the two priority 1 tasks will only contribute a weight of 6 to the objective value. It will be noted that in applying the priority weighting as described above, three priority 1 tasks may be chosen over one priority 2 task (i.e. 9 vs. 7). To further facilitate choosing the individual, higher priority task, the priority weights can be determined for priority values greater than zero by multiplying by three instead of two, priority weightₙ=3×priority weightₙ₋₁+1. Generally, then, to enforce m-way replacements, the multiplier can be chosen as m (e.g., multiplier of 4 being chosen to enforce 4-way replacements).

After receiving the task assignment data, the task assignment data can be preprocessed, as shown in block 12. The task assignment data can be preprocessed in any of a number of different manners to prepare the tasks and/or shifts for subsequent assignment, as described below. For example, the task assignment data can be preprocessed to aggregate similar tasks and/or aggregate similar shifts. In this regard, a task type is typically defined by the start day and time, duration and name of the respective task. As will be appreciated, in various instances multiple tasks of the same task type may exist in a given set of tasks. For example, two employees may be required to perform the same task at the same time. Similarly, a shift type is typically defined by the start day and time, duration, lunch break and name of the respective shift. In various instances, it is also likely that multiple shifts of the same shift type exist within a given set of shifts. By aggregating similar tasks and/or aggregating similar shifts, then, the amount of processing resources required to assign the tasks to the shifts is reduced. In other instances, such as if travel times are defined for the shifts, the shifts can be stored uniquely, otherwise they are aggregated along with the tasks.

In addition to, or in lieu of, preprocessing the task assignment data to aggregate similar tasks and/or aggregate similar shifts, the task assignment data can be preprocessed to redefine starting and ending times of each day of a set of tasks/shifts that span more than one day. In this regard, to further reduce the amount of processing resources required to assign the tasks to the shifts, the method may assign the tasks to shifts for each day separately, even in instances of tasks/shifts covering multiple days. As will be appreciated, however, one or more shifts can overlap from one day into the next. In such instances, the portion of the shift overlapping into the second day may not otherwise be assigned to any tasks that begin on the second day. As such, to minimize the number of shifts that overlap midnight, the start and end times of one or more days can be redefined based on the task (demand) activity.

Also, the task assignment data can be preprocessed to identify one or more tasks that cannot be assigned to any shifts given in the task assignment data. In this regard, a task is typically unassignable if no shifts exist to which the task may be assigned independent of any other task assignments. In other terms, an unassignable task is typically defined as a task that could not be assigned to a shift even if that task was the only task to be assigned to a given set of one or more shifts. Such instances can occur for any of a number of different reasons, typically stemming from the fact that the shifts may have been generated without explicit consideration of the tasks to be assigned to the shifts. In this regard, the shifts may be generated to cover the tasks in aggregate. In other terms, for example, a task from 12 pm-4 pm may be “covered” by two shifts, e.g., one from 9 am-2 pm and the other from 2 pm-8 pm. According to work rules, however, a task may not be split across shifts so that when these two shifts and task are considered for task/shift assignments, the task may not be assignable to any shift. As will be appreciated, then, once identified, unassignable tasks are typically flagged, and thereafter not included in the subsequent assignments of tasks to shifts.

As indicated above, to reduce the amount of processing resources required to assign the tasks to the shifts, the method can separately assign the tasks to shifts for each day of a plurality of days in the task assignment data. In this regard, the method will be described herein as assigning tasks to shifts for a single day. It should be understood, however, that the method can be extended to assign tasks to shifts for more than one day without departing from the spirit and scope of the present invention.

As shown in block 14, a threshold value can be determined from the preprocessed task assignment data. The threshold value can comprise any value associated with a set of task/shift assignments that satisfy the task assignment data. According to one advantageous embodiment, however, the threshold value can comprise a value representative of the greatest sum of task priorities associated with any set of task/shift assignments that satisfy the task assignment data, without concern for other business rules of constraints. For example, the value representative of the greatest sum of task priorities can comprise the highest sum of task priorities associated with any set of task/shift assignments that satisfy the task assignment data, without concern for other business rules or constraints. As indicated above, according to work rules, a task typically may not be split across shifts. In determining the threshold value, however, a task may be capable of being split across one or more shifts, such as according to a linear-time programming model, to thereby determine the value representative of the greatest sum of task priorities.

As the set of task/shift assignments having a value representative of the greatest sum of task priorities, which is associated with any set of task/shift assignments that satisfy the task assignment data without concern for other business rules of constraints, may not satisfy subsequently applied business rules or constraints, the threshold value may not equal the solution value of the optimum set of task/shift assignments, as described below. Also, as will be appreciated to those skilled in the art, applying business rules or constraints to the task assignment data typically decreases the solution value of subsequent task/shift assignments so that the task/shift assignments after applying the business rules and constraints typically have a lower solution value than the task/shift assignments before applying the business rules. Therefore, the threshold value actually represents an upper bound of the solution value associated with any set of task/shift assignments that satisfy the task assignment data and all of the subsequently applied business rules and constraints. In other terms, the solution value of any set of task/shift assignments after applying subsequent business rules and constraints can have any of a number of different values that are all less than or equal to the threshold value.

After preprocessing the task assignment data and determining the threshold value, the tasks can be assigned to the shifts to thereby maximize the solution value of the task/shift assignments, as shown in block 16. However, although as described herein the tasks are assigned to the shifts to maximize the solution value of the set of task/shift assignments, it should be understood that except where indicated, the tasks can equally be assigned to the shifts to maximize the total number of assigned tasks, or minimize the number of unassigned tasks, in the same manner as described herein for maximizing the solution value of the set of task/shift assignments.

In assigning the tasks to the shifts, the tasks are assigned such that any lunch breaks defined in the shifts are followed and no tasks are assigned to overlap with any lunch break of any shift. As will be appreciated, overlapping tasks cannot typically be assigned to the same shift. As such, assigning the tasks to shifts typically includes identifying sets of overlapping tasks. The sets of overlapping tasks can be identified in any of a number of different manners. According to one advantageous embodiment, however, the sets of overlapping tasks are identified according to an algorithmic graph theory technique. As will be appreciated by those skilled in the art, the sets of overlapping tasks can be represented as maximal cliques on a graph (G) including a number of vertices (V) and a number of edges (E). In this regard, a clique can be defined as a set of pairwise adjoining vertices, and a maximal clique can be defined as a clique such that the addition of any other vertex to the clique destroys the pairwise adjoint property of the clique.

Solving the maximal clique problem in general is NP-hard (nondeterministic polynomial-time hard). However, special classes of graphs exist for which the maximal clique problem may be solved in polynomial time. One such class is the class of interval graphs into which the set of task types can be easily transformed. An interval graph can be defined as a graph by which the vertices represent intervals on the real line, and edges can be drawn between all overlapping intervals (vertices). In this regard, the theory of interval graphs can be extended to identify sets of overlapping tasks, where tasks represent the intervals (or vertices of the graph) and all overlapping tasks (vertices) are connected by an edge. At this point it should be noted that two tasks overlap based on the start and end times of the respective tasks, with travel time overlaps not typically considered when generating the maximal cliques.

Any of a number of different techniques can be used to generate the maximal cliques in a task-based interval graph. In one advantageous embodiment, a linear-time programming model is used to generate all of such maximal cliques. Such a technique is generally based on the existence of vertex elimination schemes for triangulated graphs (of which interval graphs are a special case), and a fast algorithm for finding vertex elimination schemes. According to this technique, the maximal cliques can be generated over two phases. In the first phase, a perfect elimination ordering (PEO) can be found on a triangulated graph. In the second phase, this PEO can be used to find all maximal cliques of an interval graph. In this regard, tasks can be represented by intervals (or vertices of the graph), where all overlapping tasks (vertices) are connected by an edge. More particularly, the first phase of generating the maximal cliques can begin by initializing all vertex labels, L(v), to null. Next, any one vertex in a graph including n vertices can be selected (referred to as vertex w) to be number n in the PEO (i.e., the last vertex in the PEO, p(n)). Then, for each vertex, v, that is an element of the adjacency set of vertex w (i.e., Adj(w)) and that has not yet been assigned a position in the PEO, the value n can be added to the vertex label, L(v). The technique can then continue by selecting the next vertex, w, as the unassigned vertex with largest label (breaking ties arbitrarily) to be vertex p(n−1). As before, the labels of all unassigned vertices w, adjacent vertices are updated with the value n−1. Then, the above phase can continue in a similar manner for p(i), where i=n−2, . . . , 1. Upon reaching i−1, all vertices will have been assigned a position in the PEO.

Given the PEO from phase one, the second phase can find all maximal cliques of the triangulated graph. The second phase can begin by choosing the first vertex in the PEO, p(1). The set of all vertices adjacent to p(1) can then be defined as a set X such that set are at a higher position in the PEO than the vertex p(1). If no vertices are adjacent to vertex p(1), vertex p(1) can be set as its own maximal clique, and the next vertex in the PEO, can be chosen with the second phase continuing with next vertex. If at least one vertex is adjacent to vertex p(1), let vertex u=min vertex in the set X. For all vertices v, a value S(v) may be defined, and initiated to zero. Then, a vertex u's value S(u) can be determined as follows: S(u)=max {S(u), |X|−1}, where |X| denotes the cardinality of set X (i.e., the number of elements in set X). Next, consider the value S(v) maintained for vertex v. If the value S(v) satisfies the following: S(v)<|X|, the set X plus vertex v can be found to be a maximal clique. If the value S(v) does not satisfy the inequality, the next vertex in the PEO can be selected and second phase repeated. In this manner, phase two is followed for all vertices 1, . . . , n. For more information on such a technique for generating maximal cliques, see MARTIN C. GOLUMBIC, ALGORITHMIC GRAPH THEORY AND PERFECT GRAPHS (1980), the contents of which is hereby incorporated by reference in its entirety.

After identifying sets of overlapping tasks, the tasks can be assigned to the shifts while accounting for the overlapping tasks. The tasks can be assigned to the shifts in any of a number of different manners. In one advantageous embodiment, for example, the tasks are assigned to the shifts by maximizing the solution value (i.e., the sum of the task priorities) of the set of task/shift assignments, while preventing overlapping tasks from being assigned to the same shift, preventing tasks from overlapping any fixed lunch breaks defined for any shifts, preventing tasks that overlap due to travel times from being assigned to the same shift, and ensuring that linked tasks are assigned to the same shift. Written notationally, then, the tasks can be assigned to the shifts according to the following:

$$Max {\sum }_{⟨ i , j ⟩ ∈ A} {p}_{i} {x}_{i , j} \qquad Maximize Priority of Assigned Tasks$$

subject to:

$$\begin{matrix}{\sum }_{j = 1}^{m} {x}_{i , j} \leq {T}_{i} ∀ tasks i = 1 … n & Set Packing Task Constraint \\ {\sum }_{i ∈ {C}_{k} and ( i , j ) ∈ A} \leq {S}_{j} ∀ shifts , j , ∀ max cliques , k & Interval Graph Constraint \\ {x}_{i , j} + {x}_{{i}^{′} , j} \leq 1 , ∀ shifts , j , ∀ ( i , {i}^{′} ) ∈ R & Travel Time Restrictions \\ {x}_{i , j} - {x}_{{i}^{′} , j} = 0 , ∀ shifts , j , ∀ ( i , {i}^{′} ) ∈ L & Linked Task Restrictions\end{matrix}$$

Where:

i=1, . . . , n, task types;

j=1, . . . , m, shift types;

k=1, . . . , p, maximum cliques (overlapping tasks);

Tᵢ=number of tasks of type i; number of shifts of type j (if linked tasks or travel times have

Sⱼ=been defined or otherwise exist, Sⱼ may equal one as shift types will typically not be aggregated);

xᵢⱼ=number of tasks of type i assigned to shift type j;

pᵢ=priority ranking of task i;

A={<i, j>|tawk type i can be assigned to shift type j}

C=set of maximum cliques (overlapping tasks); and

R={<i, i′>|task type i and task type i′ overlap due to travel times}

L={<i, i′>| task type i and task i′ are linked together}

As shown in block 18, after assigning the tasks to the shifts while accounting for fixed lunch breaks, the solution value of the set of task/shift assignments can be compared against the threshold value (see block 14). In this regard, by relating the solution value associated with the set of task/shift assignments with the threshold value, a quantitative guarantee of the quality of the set of task/shift assignments can be generated. The solution value associated with the set of task/shift assignments can be compared to the threshold value in this manner. If the solution value of the set of task/shift assignments is within a predefined acceptable variation from the threshold value, the set of task/shift assignments can be selected as the optimum set of task/shift assignments with fixed lunch breaks, as shown in block 19. If the solution value of the set of task/shift assignments is not within the predefined acceptable variation from the threshold value, however, the method can be repeated by selecting another set of task/shift assignments, as shown in block 16. Thereafter, the solution value associated with the new set of task/shift assignments can be compared to the threshold value. In this regard, the method repeats with a new set of generated task/shift assignments until a set of task/shift assignments is generated that has an associated solution value within the predefined acceptable variation from the threshold value.

As an example, presume that a threshold value was determined to equal 100. Then, presume that the predefined acceptable variation from the threshold value was set at 5% of the threshold value. As shown in blocks 16 and 18, then, the method will repeatedly generate sets of task/shift assignments until a set of task/shift assignments is generated that has a solution value greater than or equal to 95 (i.e., 100×0.95). In other terms, presume that the set of task/shift assignments has an associated solution value within 5% of the threshold value of 100. By selecting the set of task/shift assignments as such, the optimum set of task/shift assignments with fixed lunch breaks can be considered to have a quantitative guarantee to have a solution value (i.e., sum of task priorities) within 5% of the set of task/shift assignments having a value representative of the greatest sum of task priorities (i.e., value representative of the greatest sum of task priorities of the any set of task/shift assignments after all business rules and constraints are applied). Advantageously, by determining an upper bound solution value (i.e., threshold value), the quantitative guarantee of quality can be determined and associated with the optimum set of task/shift assignments with fixed lunch breaks without actually determining the set of task/shift assignments with the highest solution value from among all of the possible sets of task/shift assignments with fixed lunch breaks.

As will be appreciated, the higher number of sets of task/shift assignments that are selected in order to find or select the optimum set of task/shift assignments, the higher the probability of selecting a set of task/shift assignments having a high level of quality. As such, by selecting a predefined acceptable variation from the threshold value with which to compare the solution value of the selected set of task/shift assignments with fixed lunch breaks, the method facilitates control over the quality of the optimum set of task/shift assignments with fixed lunch breaks and the processing time required to select the optimum set of task/shift assignments with fixed lunch breaks. In this regard, by increasing the predefined acceptable variation (thereby decreasing the desired level of quality of the optimum set of task/shift assignments), the time required to select the optimum set of task/shift assignments can be similarly decreased. Alternatively, by increasing the time required to select the optimum set of task/shift assignments, the predefined acceptable variation can be decreased thereby increasing the desired level of quality.

As will be appreciated, in various instances, although the set of shifts may define one or more fixed lunch breaks at specified times, the lunch breaks may be permitted to float within respective shifts, if so desired. In other terms, the lunch breaks may be permitted to have the start and end times of the respective lunch breaks determined as the tasks are assigned to the shifts, or after the tasks are assigned to the shifts. By determining the lunch breaks start/end times during or after assigning the tasks, the lunch breaks can be positioned within the respective shifts to thereby further maximize the number of assigned tasks, or maximize the solution value, in the set of task/shift assignments. Thus, after assigning the tasks to the shifts, it can be determined whether the lunch breaks are permitted to float within given shifts or whether the shifts must be fixed, as shown in block 20. The determination regarding floating lunch breaks can be made in any of a number of different manners, such as by user preferences. If the lunch breaks are permitted to float, the set of task/shift assignments are selected as the optimum set of task/shift assignments, as shown in block 34.

Even if lunch breaks are permitted to float, it will be appreciated that the optimum set of task/shift assignments with floating lunch breaks may not provide a substantial improvement in the solution value over the solution value of the set of task/shift assignments with fixed lunch breaks (see block 16). It will also be appreciated that the process of assigning tasks to shifts with floating lunch breaks can require a substantial amount of resources. As such, to avoid consuming such substantial resources for a set of task/shift assignments that amounts to only an insignificant improvement, the solution value of the set of task/shift assignments with fixed lunch breaks can be compared to an upper bound usefulness, or a threshold usefulness, where the threshold usefulness can be expressed as a priority value. By comparing the solution value of the set of task/shift with fixed lunch breaks to a threshold usefulness, it can be determined whether determining an optimum set of task/shift assignments with floating lunch breaks will likely provides a substantial improvement in the solution value of the optimum set of task/shift assignments.

Thus, if the lunch breaks permitted to float, it can be determined whether determining an optimum set of task/shift assignments with floating lunch breaks are useful by ignoring the fixed lunch breaks defined by the set of shifts, and thereafter again assigning the tasks to the shifts, as shown in block 24. By assigning the tasks to the shifts while ignoring the fixed lunch breaks, the threshold usefulness can be determined. More particularly, the tasks can again be assigned to the shifts to maximize the solution value (i.e., sum of task priorities), while ignoring the fixed lunch breaks, preventing overlapping tasks from being assigned to the same shift, and preventing tasks that overlap due to travel times from being assigned to the same shift. The tasks can be assigned to the shifts according to any of a number of different techniques, but according to one advantageous embodiment, the tasks are assigned to the shifts in the same manner as described above, except that any fixed lunch breaks defined for the shifts are ignored.

From the set of task/shift assignments without fixed lunch breaks, a threshold usefulness can be determined from the set of task/shift assignments, as shown in block 24. For example, the threshold usefulness can equal the solution value of an optimum set of task/shift assignments without fixed lunch breaks, where the optimum set of task/shift assignments without fixed lunch breaks can be determined in a manner similar to that described above for determining the optimum set of task/shift assignments with fixed lunch breaks. As will be appreciated, the threshold usefulness can represent an upper bound of the solution value for any set of task/shift assignments satisfying the task assignment data and all of the previously applied business rules or constraints, except lunch breaks. The solution value of any set of task/shift assignments with floating lunch breaks, then, will typically be less than or equal to the threshold usefulness. In this regard, whether accounting for floating lunch breaks will likely provide a significant improvement in the solution value can be determined based upon a variation of the solution value of optimum the set of task/shift assignments with fixed lunch breaks from the threshold usefulness. As such, after determining the threshold usefulness, the solution value of the optimum set of task/shift assignments with fixed lunch breaks can be compared to the threshold usefulness to thereby determine whether accounting for floating lunch breaks will likely provide a significant improvement in solution value, as shown in block 26.

The solution value of the optimum set of task/shift assignments with fixed lunch breaks can be compared to the threshold usefulness according to any of a number of different techniques. In one advantageous embodiment, the solution value of the optimum set of task/shift assignments with fixed lunch breaks is compared with the threshold usefulness to determine whether the solution value of the optimum set of task/shift assignments with fixed lunch breaks has at least a predefined variation from the threshold usefulness. The predefined variation can be expressed in any of a number of different manners, such as a difference in the values or a percentage difference. For example, the predefined variation can be expressed as a 20% difference from the threshold usefulness. Thus, in this example, the solution value of the optimum set of task/shift assignments with fixed lunch breaks can be compared with the threshold usefulness to determine whether the solution value of the optimum set of task/shift assignments with fixed lunch breaks has at least a 20% difference from the threshold usefulness. As will be appreciated, the threshold usefulness can represent an upper bound of usefulness and the solution value of the optimum set of task/shift assignments with fixed lunch breaks can represent a lower bound of acceptable priority. Thus, the comparison can typically be expressed in the negative as determining whether the threshold usefulness is at least a predetermined variation greater than the solution value of the optimum set of task/shift assignments with fixed lunch breaks.

If the solution value of the optimum set of task/shift assignments with fixed lunch breaks does not have at least a predefined variation from the threshold usefulness, it can be determined that accounting for floating lunch breaks will not likely provide a significant improvement in the solution value. In such instances, the optimum set of task/shift assignments with fixed lunch breaks can be selected as the final, optimum set of task/shift assignments, as shown in block 34. If the solution value of the optimum set of task/shift assignments with fixed lunch breaks does have at least the predefined variation, however, the method can continue by assigning the tasks to the shifts while accounting for floating lunch breaks. In this regard, the fixed lunch breaks defined for the shifts can be ignored, with floating lunch breaks for the respective shifts defined as additional, “lunch” tasks, as shown in block 28.

With the floating lunch breaks defined as additional lunch tasks, the tasks (including the respective lunch tasks) can be assigned to the shifts such that each shift requiring a lunch break has one or more tasks and a lunch task assigned to the respective shift, with none of the tasks (including lunch tasks) overlapping. The tasks can be assigned to the shifts in any of a number of different manners. According to one advantageous embodiment, the tasks are assigned to the shifts according to a column generation technique. According to this technique, the optimum set of task/shift assignments with fixed lunch breaks, as such may be determined as described above, can be used to generate the columns of an initial master problem, as shown in block 30. The duals from the constraints that (a) tasks are assigned to no more than the number of available shifts (i.e., shifts upper bound constraints), and that (b) each task is assigned to a shift (or is slack) (i.e., task coverage constraints) can then be utilized in the objective function (i.e., minimize reduce cost) of one or more subproblems, where each subproblem generally adds an assignment of one or more tasks (including lunch tasks) to a shift, as shown in block 32.

After performing each subproblem, then, the master problem can be utilized to generate a set of task/shift assignments from the optimum set of task/shift assignments with fixed lunch breaks and each assignment added by the respective subproblem and all previously performed subproblems, as shown in block 34. The column generation technique can then continue until the sets of task/shift assignments generated by the master problem cease to show a measurable improvement over previously sets of task/shift assignments generated by the master problem, as shown in block 36. More particularly, for example, the column generation technique can continue until either (a) all subproblems have non-negative objective values, or (b) within the last n (e.g., 5) iterations (i.e., last n sets of task/shift assignments generated by the master problem) the percentage difference between the largest solution value (i.e., nth previous iteration value) and the smallest solution value (i.e. current value) is no greater than a predetermined threshold, such as one percent.

Written notationally, the column generation technique according to one embodiment can be represented as follows:

Master Problem:

$$Min {\sum }_{i = 1}^{n} {p}_{i} {z}_{i} \qquad Minimize Unassigned Tasks$$

subject to:

$$\begin{matrix}{\sum }_{i ∈ C} {y}_{c} + {z}_{i} \geq {T}_{i} ∀ tasks , i & Task Coverage Constraint \\ {\sum }_{c ∈ J} {y}_{c} \leq {S}_{j} ∀ shifts , j & Shift Upper Bound Constraint\end{matrix}$$

Where:

i=1, . . . , n, task types, I (does not include lunch tasks);

J=1, . . . , m, shift types, J;

C=1, . . . , q, task-to-shift assignments, C

Tᵢ=number of tasks of type i;

Sⱼ=number of shifts of type j;

pᵢ=priority ranking of task i;

zᵢ=number of unassigned tasks of type i; and

y_{c}=number of tasks-to-shift assignments, c

Subproblem:

$$Min - ( a + {\sum }_{i = 1}^{n} {b}_{i} {x}_{i} ) \qquad Minimize Reduced Cost$$

subject to:

$$\begin{matrix}{x}_{i} = 0 , iff ( i , j ) ∉ A & Invalid Tasks \\ {\sum }_{i ∈ {C}_{k} and ( i , j ) ∈ A} \leq 1 ∀ max cliques , k & Interval Graph Constraint \\ {\sum }_{i = n + 1}^{l} {x}_{i} = 1 , iff shift requires lunch & Lunch Assignment Constraint \\ {x}_{i} + {x}_{{i}^{′}} \leq 1 ∀ ( i , {i}^{′} ) ∈ R & Travel Time Restrictions \\ {x}_{i , j} - {x}_{{i}^{′} j} = 0 , ∀ ( i , {i}^{′} ) ∈ L & Linked Task Restrictions\end{matrix} \\ Where : \\ i = 1 , … , n , non lunch task types , and n + 1 , … , 1 , lunch task type s ; \\ j = fixed shift per subproblem ; \\ k = 1 , … , p , maximum cliques ( overlapping tasks ) ; \\ {x}_{i} = \{ \begin{matrix}1 & if task type i is assigned to the fixed shift type j , \\ 0 & otherwise ;\end{matrix} \\ a = dual shift cost ; \\ {b}_{i} = dual task cost of task i \\ A = \{ < i , j > \vert task type i can be assigned to shift type j \} \\ C = set of maximum cliques ( overlapping tasks ) ; and \\ R = \{ < i , {i}^{′} > \vert task type i and task type {i}^{′} overlap due to travel times \} \\ L = \{ < i , {i}^{′} > \vert task type i and task type {i}^{′} are linked together \}$$

In the subproblem, the invalid tasks identify those tasks that may not be assigned to the given shift type, and the interval graph constraint prevents overlapping tasks from being assigned to the same shift. Also in the subproblem, the lunch assignment constraint ensures that a lunch task is assigned to the given shift (if the given shift requires such an assignment), the travel time constraint ensures that tasks overlapping due to travel times are not assigned to the same shift, and the linked task restrictions ensure that linked tasks are assigned to the same shift.

As shown in block 36, after concluding the column generation technique, the final, optimum set of task/shift assignments, or the optimum set of task/shift assignments with floating lunch breaks, is selected. In one embodiment, for example, the final, optimum set of task/shift assignments comprises the last set of task/shift assignments generated by the master problem according to the column generation technique. As will be appreciated, because the column generation technique began with the optimum set of task/shift assignments with fixed lunch breaks, the final, optimum set of task/shift assignments with floating lunch breaks will necessarily have a solution value at least as great as the solution value of the optimum set of task/shift assignments with fixed lunch breaks. In other terms, the optimum set of task/shift assignments with floating lunch breaks will necessarily have an associated solution value within the predefined acceptable variation from the threshold value. Thus, the optimum set of task/shift assignments can have a final qualitative measure of quality based upon the solution value associated with the optimum set of task/shift assignments with floating lunch breaks, and the threshold value.

After selecting the optimum set of task/shift assignments with floating lunch breaks, then, this final quantitative measure of quality can be determined based upon the threshold value and the solution value of the optimum set of task/shift assignments with floating lunch breaks, if so desired. In this regard, as before, by relating the solution value of the optimum set of task/shift assignments with floating lunch breaks to the threshold value, a quantitative guarantee of the quality of the optimum set of task/shift assignments with floating lunch breaks can be generated. The solution value associated with the optimum set of task/shift assignments with floating lunch breaks can be compared to the threshold value in this manner.

Embodiments of the present invention therefore provide improved systems, methods and computer program products for assigning at least one task to at least one shift. Embodiments of the present invention are capable of generating at least one, and more typically, an optimum set of task/shift assignments based upon a quantitative measure of quality to thereby facilitate selecting an optimum set of task/shift assignments that has a desired level of quality. In this regard, embodiments of the present invention are capable of repeatedly selecting different sets of task/shift assignments with fixed or floating lunch breaks until a set of task/shift assignments is found that has the desired level of quality, thereby providing increased control over the quality of the optimum set of task/shift assignments and the processing time required to select the optimum set of task/shift assignments.

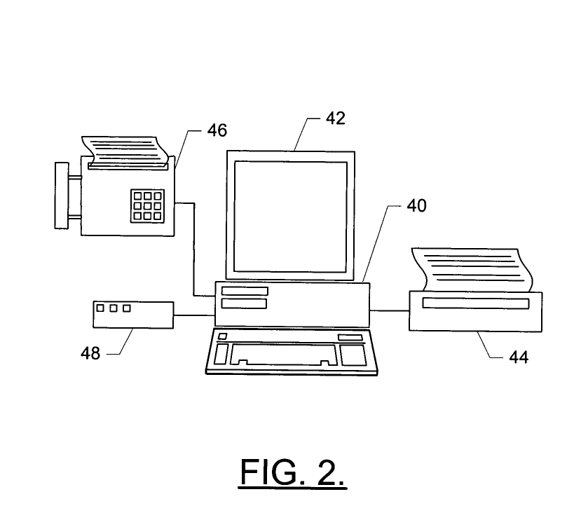

As shown in FIG. 2, the system of the present invention is typically embodied by a processing element and an associated memory device, both of which are commonly comprised by a computer 40 or the like. In this regard, as indicated above, the method of embodiments of the present invention can be performed by the processing element manipulating data stored by the memory device. The computer can include a display 42 for presenting information relative to performing embodiments of the present invention, including the various sets of schedules as determined according to embodiments of the present invention. To plot information relative to embodiments of the method of the present invention, the computer can further include a printer 44.

Also, the computer 40 can include a means for locally or remotely transferring the information relative to embodiments of the method of the present invention. For example, the computer can include a facsimile machine 46 for transmitting information to other facsimile machines, computers or the like. Additionally, or alternatively, the computer can include a modem 48 to transfer information to other computers or the like. Further, the computer can include an interface (not shown) to a network, such as a local area network (LAN), and/or a wide area network (WAN). For example, the computer can include an Ethernet Personal Computer Memory Card International Association (PCMCIA) card configured to transmit and receive information to and from a LAN, WAN or the like.

According to one aspect of the present invention, the system of the present invention generally operates under control of a computer program product. The computer program product for performing the methods of embodiments of the present invention includes a computer-readable storage medium, such as the non-volatile storage medium, and computer-readable program code portions, such as a series of computer instructions, embodied in the computer-readable storage medium. It should be understood that the computer-readable program code portions may include separate executable portions for performing distinct functions to accomplish methods of embodiments of the present invention. Additionally, or alternatively, one or more of the computer-readable program portions may include one or more executable portions for performing more than one function to thereby accomplish methods of embodiments of the present invention.

In this regard, FIGS. 1A and 1B are flowcharts of methods, systems and program products according to the invention. It will be understood that each block or step of the flowchart, and combinations of blocks in the flowchart, can be implemented by computer program instructions. These computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that each block or step of the flowchart, and combinations of blocks or steps in the flowchart, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of assigning at least one task to at least one shift comprising:
receiving task assignment data, wherein the task assignment data includes at least one task, at least one shift and at least one priority associated with the at least one task;
generating at least one set of task/shift assignments based upon the task assignment data, wherein each set of task/shift assignments includes at least one task assigned to at least one shift, and wherein each set of task/shift assignments has an associated solution value based upon the at least one priority associated with the at least one task included within the respective task/shift assignment; and
selecting an optimum set of task/shift assignments based upon the generated at least one set of task/shift assignments and a quantitative measure of quality associated with the optimum set of task/shift assignments, wherein the quantitative measure of quality is based upon a threshold value and a solution value associated with the optimum set of task/shift assignments.

2. A method according to claim 1 further comprising:
determining a threshold value based upon the task assignment data, wherein determining a threshold value comprises determining a value representative of a maximum sum of the at least one priority associated with the at least one task included within any set of task/shift assignments capable of being selected in accordance with the task assignment data.

3. A method according to claim 1, wherein selecting an optimum set of task/shift assignments comprises selecting an optimum set of task/shift assignments that has an associated solution value within a predefined acceptable variation from the threshold value.

4. A method according to claim 3, wherein generating at least one set of task/shift assignments and selecting an optimum set of task/shift assignments comprises:
generating a set of task/shift assignments; and
comparing a solution value associated with the set of task/shift assignments to the threshold value, wherein generating a set of task/shift assignments and comparing the solution value comprise repeatedly generating a set of task/shift assignments and repeatedly comparing the solution value until an optimum set of task/shift assignments is selected that has an associated solution value within a predefined acceptable variation from the threshold value.

5. A method according to claim 1, wherein generating at least one set of task/shift assignments comprises generating at least one set of task/shift assignments in accordance with at least one business rule.

6. A method according to claim 5, wherein generating at least one set of task/shift assignments in accordance with at least one business rule comprises generating at least one set of task/shift assignments to thereby maximize a sum of the at least one priority associated with the at least one task included within a set of task/shift assignments while at least one of preventing any pair of overlapping tasks from being assigned to the same shift, preventing any task from overlapping any fixed lunch break defined for any shift, preventing any pair of tasks that overlap due to a travel time associated with each of the pair of tasks from being assigned to the same shift, and ensuring that any plurality of linked tasks are assigned to the same shift.

7. A method according to claim 1, wherein generating at least one set of task/shift assignments comprises generating at least one set of task/shift assignments to incorporate at least one fixed lunch break when the task assignment data includes at least one shift defining at least one lunch break, and wherein selecting an optimum set of task/shift assignments comprises selecting an optimum set of task/shift assignments with at least one fixed lunch break.

8. A method according to claim 7 further comprising:
determining whether the at least one lunch break defined for at least one shift is permitted to float within the respective at least one shift;
determining whether an optimum set of task/shift assignments with at least one floating lunch break provides an improvement over the optimum set of task/shift assignments with at least one fixed lunch break, wherein the determination is made based upon the solution value of the optimum set of task/shift assignments with at least one fixed lunch break;
generating at least one set of task/shift assignments to incorporate at least one floating lunch break if the at least one lunch break is permitted to float and the optimum set of task/shift assignments with at least one floating lunch break provides an improvement; and
selecting an optimum set of task/shift assignments with at least one floating lunch break based upon the generated at least one set of task/shift assignments with at least one floating lunch break, wherein the optimum set of task/shift assignments with at least one floating lunch break is selected if the at least one set of task/shift assignments with at least one floating lunch break is generated.

9. A method according to claim 8 further comprising:
determining a threshold usefulness based upon a solution value associated with a set of task/shift assignments independent of at least one fixed lunch break, wherein determining whether an optimum set of task/shift assignments with at least one floating lunch break provides an improvement comprises determining whether an optimum set of task/shift assignments with at least one floating lunch break provides an improvement further based upon the threshold usefulness.

10. A system for assigning at least one task to at least one shift comprising:
a processing element capable of receiving task assignment data including at least one task, at least one shift and at least one priority associated with the at least one task, wherein the processing element is capable of generating at least one set of task/shift assignments based upon the task assignment data, wherein each set of task/shift assignments includes at least one task assigned to at least one shift, wherein each set of task/shift assignments has an associated solution value based upon the at least one priority associated with the at least one task included within the respective task/shift assignment, wherein the processing element is also capable of selecting an optimum set of task/shift assignments based upon the generated at least one set of task/shift assignments and a quantitative measure of quality associated with the optimum set of task/shift assignments, and wherein the quantitative measure of quality is based upon a threshold value and a solution value associated with the optimum set of task/shift assignments.

11. A system according to claim 10, wherein the processing element is further capable of determining a threshold value based upon the task assignment data, wherein the processing element is capable of determining the threshold value by determining a value representative of a maximum sum of the at least one priority associated with the at least one task included within any set of task/shift assignments capable of being selected in accordance with the task assignment data.

12. A system according to claim 10, wherein the processing element is capable of selecting an optimum set of task/shift assignments that has an associated solution value within a predefined acceptable variation from the threshold value.

13. A system according to claim 12, wherein the processing element is capable of generating at least one set of task/shift assignments and selecting an optimum set of task/shift assignments by:
generating a set of task/shift assignments; and
comparing a solution value associated with the set of task/shift assignments to the threshold value, wherein the processing element is capable of repeatedly generating a set of task/shift assignments and repeatedly comparing the solution value until an optimum set of task/shift assignments is selected that has an associated solution value within a predefined acceptable variation from the threshold value.

14. A system according to claim 10, wherein the processing element is capable of generating the at least one set of task/shift assignments in accordance with at least one business rule.

15. A system according to claim 14, wherein the processing element is capable of generating the at least one set of task/shift assignments in accordance with at least one business rule by generating at least one set of task/shift assignments to thereby maximize a sum of the at least one priority associated with the at least one task included within a set of task/shift assignments while at least one of preventing any pair of overlapping tasks from being assigned to the same shift, preventing any task from overlapping any fixed lunch break defined for any shift, preventing any pair of tasks that overlap due to a travel time associated with each of the pair of tasks from being assigned to the same shift, and ensuring that any plurality of linked tasks are assigned to the same shift.

16. A system according to claim 10, wherein the processing element is capable of generating at least one set of task/shift assignments to incorporate at least one fixed lunch break when the task assignment data includes at least one shift defining at least one lunch break, and wherein the processing element is capable of selecting an optimum set of task/shift assignments with at least one fixed lunch break.

17. A system according to claim 16, wherein the processing element is further capable of determining whether the at least one lunch break defined for at least one shift is permitted to float within the respective at least one shift, and thereafter determining whether an optimum set of task/shift assignments with at least one floating lunch break provides an improvement over the optimum set of task/shift assignments with at least one fixed lunch break, wherein the processing element is capable of making the determination based upon the solution value of the optimum set of task/shift assignments with at least one fixed lunch break, wherein the processing element is also capable of generating at least one set of task/shift assignments to incorporate at least one floating lunch break if the at least one lunch break is permitted to float and the optimum set of task/shift assignments with at least one floating lunch break provides an improvement, wherein the processing element is additionally capable of selecting an optimum set of task/shift assignments with at least one floating lunch break based upon the generated at least one set of task/shift assignments with at least one floating lunch break, wherein the processing element is capable of selecting the optimum set of task/shift assignments with at least one floating lunch break if the at least one set of task/shift assignments with at least one floating lunch break is generated.

18. A system according to claim 17, wherein the processing element is further capable of determining a threshold usefulness based upon a solution value associated with a set of task/shift assignments independent of at least one fixed lunch break, and wherein the processing element is capable of determining whether an optimum set of task/shift assignments with at least one floating lunch break provides an improvement further based upon the threshold usefulness.

19. A computer program product for assigning at least one task to at least one shift, the computer program product comprising a computer-readable storage medium having computer-readable program code portions stored therein, the computer-readable program portions comprising:
a first executable portion for receiving task assignment data, wherein the task assignment data includes at least one task, at least one shift and at least one priority associated with the at least one task;
a second executable portion for generating at least one set of task/shift assignments based upon the task assignment data, wherein each set of task/shift assignments includes at least one task assigned to at least one shift, and wherein each set of task/shift assignments has an associated solution value based upon the at least one priority associated with the at least one task included within the respective task/shift assignment; and
a third executable portion for selecting an optimum set of task/shift assignments based upon the generated at least one set of task/shift assignments and a quantitative measure of quality associated with the optimum set of task/shift assignments, wherein the quantitative measure of quality is based upon a threshold value and a solution value associated with the optimum set of task/shift assignments.

20. A computer program product according to claim 19 further comprising:
a fourth executable portion for determining a threshold value based upon the task assignment data, wherein the fourth executable portion determines the threshold value by determining a value representative of a maximum sum of the at least one priority associated with the at least one task included within any set of task/shift assignments capable of being selected in accordance with the task assignment data.

21. A computer program product according to claim 19, wherein the third executable portion selects an optimum set of task/shift assignments that has an associated solution value within a predefined acceptable variation from the threshold value.

22. A computer program product according to claim 21, wherein the second executable portion and third executable portion generating at least one set of task/shift assignments and selecting an optimum set of task/shift assignments, respectively, by:
generating a set of task/shift assignments; and
comparing a solution value associated with the set of task/shift assignments to the threshold value, wherein the second executable portion and third executable portion repeatedly select a set of task/shift assignments and repeatedly compare the solution value, respectively, until an optimum set of task/shift assignments is selected that has an associated solution value within a predefined acceptable variation from the threshold value.

23. A computer program product according to claim 19, wherein the second executable portion generates at least one set of task/shift assignments in accordance with at least one business rule.

24. A computer program product according to claim 23, wherein the second executable portion generates at least one set of task/shift assignments in accordance with at least one business rule by generating at least one set of task/shift assignments to thereby maximize a sum of the at least one priority associated with the at least one task included within a set of task/shift assignments while at least one of preventing any pair of overlapping tasks from being assigned to the same shift, preventing any task from overlapping any fixed lunch break defined for any shift, preventing any pair of tasks that overlap due to a travel time associated with each of the pair of tasks from being assigned to the same shift, and ensuring that any plurality of linked tasks are assigned to the same shift.

25. A computer program product according to claim 19, wherein the second executable portion generates at least one set of task/shift assignments to incorporate at least one fixed lunch break when the task assignment data includes at least one shift defining at least one lunch break, and wherein the third executable portion selects an optimum set of task/shift assignments with at least one fixed lunch break.

26. A computer program product according to claim 25 further comprising:
a fourth executable portion for determining whether the at least one lunch break defined for at least one shift is permitted to float within the respective at least one shift;
a fifth executable portion for determining whether an optimum set of task/shift assignments with at least one floating lunch break provides an improvement over the optimum set of task/shift assignments with at least one fixed lunch break, wherein the determination is made based upon the solution value of the optimum set of task/shift assignments with at least one fixed lunch break;
a sixth executable portion for generating at least one set of task/shift assignments to incorporate at least one floating lunch break if the at least one lunch break is permitted to float and the optimum set of task/shift assignments with at least one floating lunch break provides an improvement; and
a seventh executable portion for selecting an optimum set of task/shift assignments with at least one floating lunch break based upon the generated at least one set of task/shift assignments with at least one floating lunch break, wherein the optimum set of task/shift assignments with at least one floating lunch break is selected if the at least one set of task/shift assignments with at least one floating lunch break is generated.

27. A computer program product according to claim 26 further comprising:
an eighth executable portion for determining a threshold usefulness based upon a solution value associated with a set of task/shift assignments independent of at least one fixed lunch break, wherein fifth executable portion determines whether an optimum set of task/shift assignments with at least one floating lunch break provides an improvement further based upon the threshold usefulness.
